(19) United States
(12) Patent Application Publication
(10) Pub. No.: US 2024/0041086 A1
(43) Pub. Date: Feb. 8, 2024

(54) Frozen Meat Treat Device and Method

(71) Applicant: Charles Stevens, Canton, OH (US)

(72) Inventor: Charles Stevens, Canton, OH (US)

(21) Appl. No.: 17/880,095

(22) Filed: Aug. 3, 2022

(51) Int. Cl. A23N 17/00; A23K 10/20; A23K 40/30; A23K 50/48; A23B 4/06

(52) U.S. Cl. CPC A23N 17/002; A23K 10/20; A23K 40/30; A23K 50/48; A23B 4/068; A23V 2002/00

(57) ABSTRACT

A frozen meat treat device and method for freezing the treat in an ice cube includes a treat being an indulgence for a canine or a pet animal. The treat is a cubic shape and is a meat. The meat is baked at a temperature for partially baking the meat thus retaining a juice of the meat. Furthermore, an ice cube enwraps the treat. The ice cube is a larger cubic shape being large-scaled relative to the cubic shape of the treat. The ice cube includes frozen water and the juice of the meat for quenching a thirst of the canine or the pet animal.

### CROSS-REFERENCE TO RELATED APPLICATIONS

Not Applicable

### STATEMENT REGARDING FEDERALLY SPONSORED RESEARCH OR DEVELOPMENT

Not Applicable

### The Names of the Parties to a Joint Research Agreement

Not Applicable

### Incorporation-by-Reference of Material Submitted on a Compact Disc or as a Text File Via the Office Electronic Filing System

Not Applicable

### STATEMENT REGARDING PRIOR DISCLOSURES BY THE INVENTOR OR JOINT INVENTOR

Not Applicable

### BACKGROUND OF THE INVENTION

### Field of the Invention

The disclosure relates to canine treat device and more particularly pertains to a new canine treat device for freezing the treat in an ice cube.

### Description of Related Art Including Information Disclosed Under 37 CFR 1.97 and 1.98

The prior art relates to canine treat devices. The prior art includes a variety of canine treat devices configured for being cooled or frozen. Furthermore, the prior art includes a variety of canine treat devices comprising a meat. Known prior art lacks a canine treat device comprising a meat being cooked prior to being enwrapped by an ice cube.

### BRIEF SUMMARY OF THE INVENTION

An embodiment of the disclosure meets the needs presented above by generally comprising a treat is configured for being an indulgence for a canine or a pet animal. The treat is a cubic shape and is a meat being configured for being baked at a temperature being configured for partially baking the meat wherein retaining a juice of the meat. Furthermore, an ice cube enwraps the treat. The ice cube is a larger cubic shape being large-scaled relative to the cubic shape of the treat. The ice cube comprises frozen water and the juice of the meat being configured for quenching a thirst of the canine or the pet animal.

Another embodiment of the disclosure includes a method comprising a step of cutting a meat into a treat and forming the treat into a cubic shape prior to baking the treat at a temperature of one hundred thirty five Centigrade from ten to twenty minutes. Subsequently, the user places the treat within a cavity of an ice tray prior to filling the cavity with water wherein submerging the treat within water in the cavity. The user positions the ice tray in a space having an ambient temperature less than zero Centigrade wherein producing an ice cube around the treat within the cavity of the ice tray. The user removes the ice cube from the cavity of the ice tray and feeds the ice cube to a canine or a pet animal.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded view of a frozen meat treat device and method according to an embodiment of the disclosure.

FIG. 2 is an isometric in-use view of an embodiment of the disclosure.

FIG. 3 is an exploded view of an embodiment of the disclosure.

FIG. 4 is a cross-sectional view of an embodiment of the disclosure taken from FIG. 3 of Line 4-4.

FIG. 5 is an in-use view of an embodiment of the disclosure.

FIG. 6 is a flow chart view of an embodiment of a method of the disclosure.

### DETAILED DESCRIPTION OF THE INVENTION

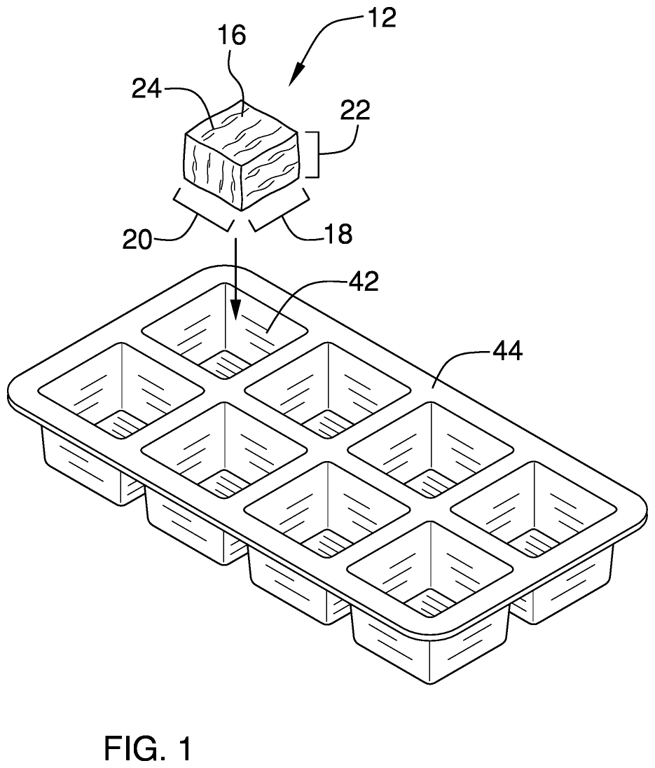

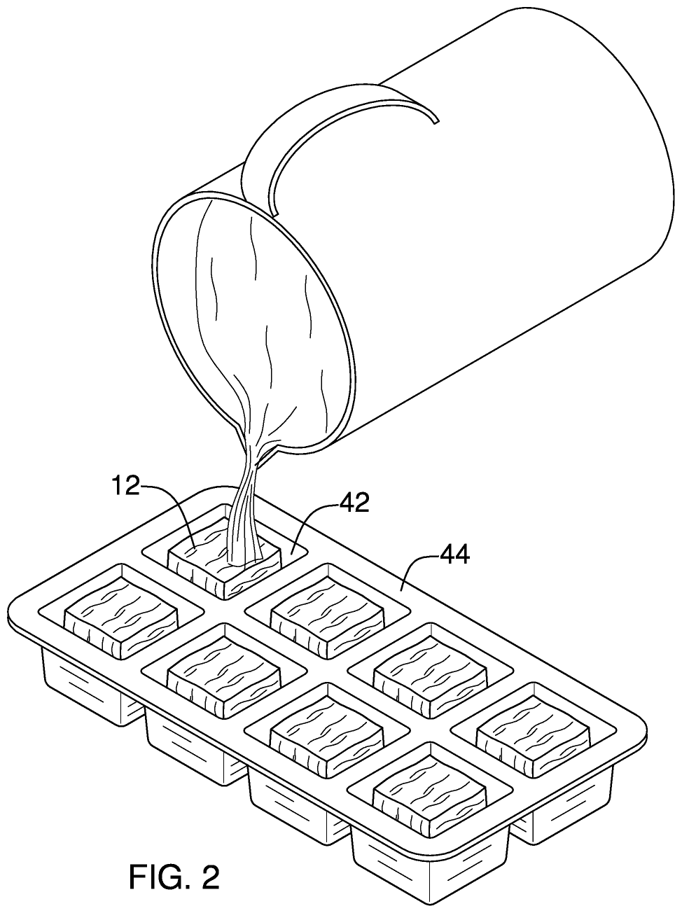

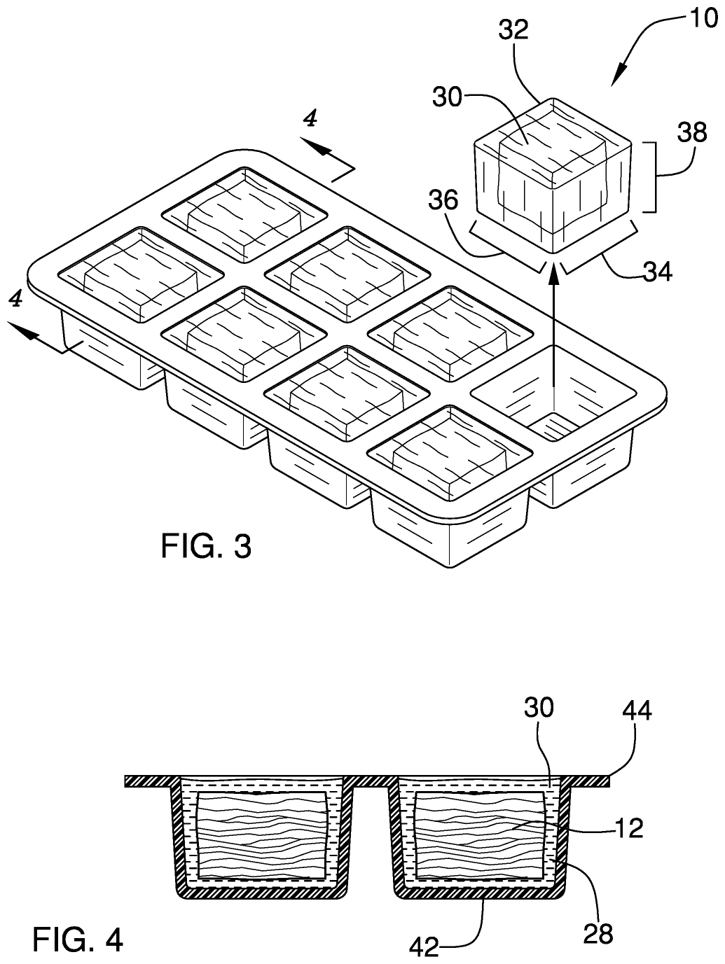

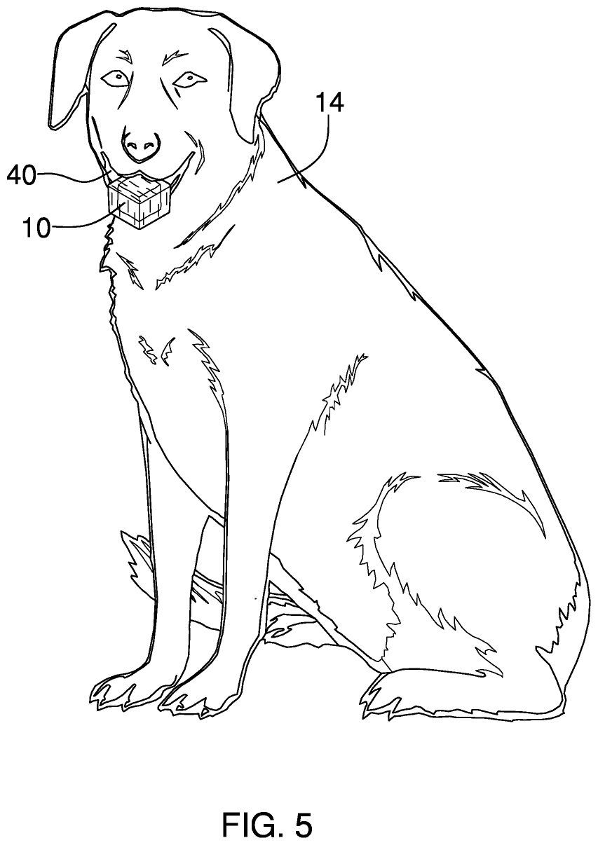

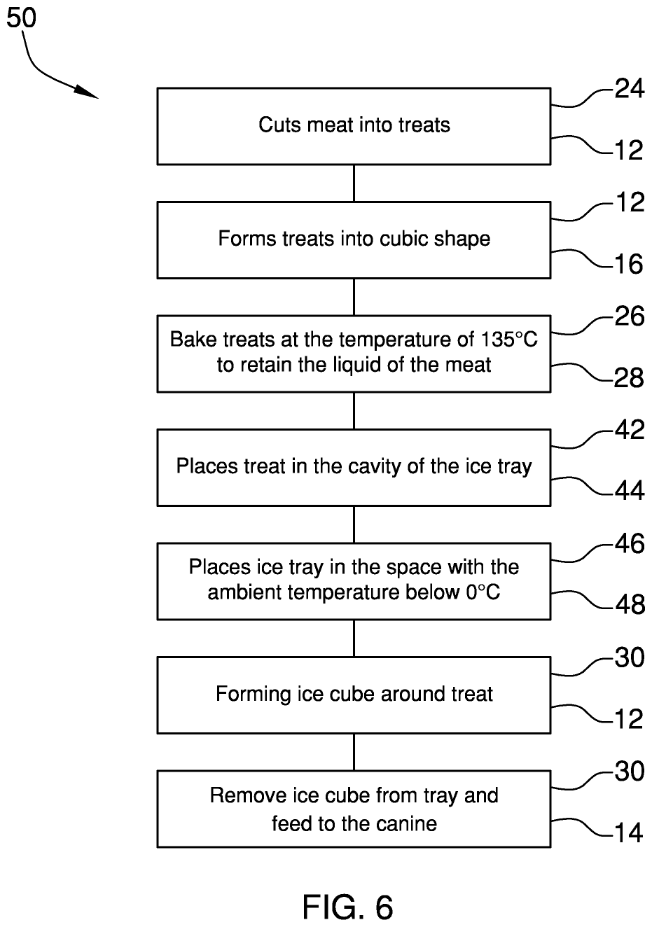

With reference now to the drawings, and in particular to FIGS. 1 through 6 thereof, a new canine treat device embodying the principles and concepts of an embodiment of the disclosure and generally designated by the reference numeral 10 will be described.

As best illustrated in FIGS. 1 through 6, the frozen meat treat device and method 10 generally comprises a treat 12. The treat 12 is configured for being an indulgence for a canine 14 or a pet animal, wherein the treat is a dessert or a reward. The treat 12 is a cubic shape 16 comprising a length 18 being configured for being fifty one millimeters, a width 20 being configured for being fifty one millimeters, and a height 22 being configured for being fifty one millimeters. The treat 12 is a meat 24 which includes a beef, a chicken, or a liver of a livestock. The meat 24 is configured for being baked at a temperature 26 configured for being one hundred thirty five Centigrade for partially baking the meat 24 wherein retaining a juice 28 of the meat 24. The juice 28 of the meat 24 will be a supplementary element of the treat 12.

An ice cube 30 enwraps the treat 12. The ice cube 30 is a larger cubic shape 32 being large-scaled relative to the cubic shape 16 of the treat 12. Moreover, the larger cubic shape 32 comprises a length 34 greater than the length 18 of the cubic shape 16 of the treat 12 wherein the length 34 of the larger cubic shape 32 is configured for being greater than fifty one millimeters. Furthermore, the larger cubic shape 32 has a width 36 greater than the width 20 of the cubic shape 16 of the treat 12 wherein the width 36 of the larger cubic shape 32 is configured for being greater than fifty one millimeters. Additionally, the larger cubic shape 32 has a height 38 greater than the height 22 of the cubic shape 16 of the treat 12 wherein the height 38 of the larger cubic shape 32 is configured for being greater than fifty one millimeters. So forth, the ice cube 30 comprises frozen water and the juice 28 of the meat 24 being configured for quenching thirst of the canine 14 or the pet animal. As the ice cube 30 melts within a mouth 40 of the canine 14 or the pet animal, the treat 12 becomes revealed.

In use, the user follows a method 50 by cutting the meat 24 into the treat 12 and forming the treat 12 into the cubic shape 16 prior to baking the treat 12 at the temperature 26 of one hundred thirty five Centigrade from ten to twenty minutes. The treat 12 is configured for being baked so the meat 24 is medium rare and retains the juice 28 of the meat 12. Subsequently, the user places the treat 12 within a cavity 42 of an ice tray 44 prior to filling the cavity 42 with water wherein submerging the treat 12 within water in the cavity 42. The user positions the ice tray 44 in a space 46 having an ambient temperature 48 less than zero Centigrade wherein producing the ice cube 30 around the treat 12 within the cavity 42 of the ice tray 44. The user removes the ice cube 30 from the cavity 42 of the ice tray 44 and feeds the ice cube 20 to the canine 14 or the pet animal. The ice cube 30 will comprise the frozen water and the juice 28 from the meat 24, thus enticing the canine 14 or the pet animal to indulge the ice cube 30.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A frozen meat treat device configured for being indulged by a canine or a pet animal, the frozen meat treat device comprising:
a treat being configured for being an indulgence for a canine or a pet animal, the treat being a cubic shape, the treat being a meat, the meat being configured for being baked at a temperature, the temperature being configured for partially baking the meat wherein retaining a juice of the meat; and
an ice cube enwrapping the treat, the ice cube being a larger cubic shape, the larger cubic shape being large-scaled relative to the cubic shape of the treat, the ice cube comprising frozen water and the juice of the meat, the ice cube being configured for quenching a thirst of the canine or the pet animal.

2. The frozen meat treat device of claim 1, further comprising the cubic shape having a length.

3. The frozen meat treat device of claim 2, further comprising the length of the cubic shape being configured for being fifty one millimeters.

4. The frozen meat treat device of claim 2, further comprising the cubic shape having a width.

5. The frozen meat treat device of claim 4, further comprising the width of the cubic shape being configured for being fifty one millimeters.

6. The frozen meat treat device of claim 4, further comprising the cubic shape having a height.

7. The frozen meat treat device of claim 6, further comprising the height of the cubic shape being configured for being fifty one millimeters.

8. The frozen meat treat device of claim 1, further comprising the meat being a beef.

9. The frozen meat treat device of claim 1, further comprising the meat being a chicken.

10. The frozen meat treat device of claim 1, further comprising the meat being a liver of a livestock.

11. The frozen meat treat device of claim 1, further comprising the temperature being configured for being one hundred thirty five Centigrade.

12. The frozen meat treat device of claim 2, further comprising the larger cubic shape having a length greater than the length of the cubic shape of the treat.

13. The frozen meat treat device of claim 12, further comprising the length of the larger cubic shape being configured for being greater than fifty one millimeters.

14. The frozen meat treat device of claim 4, further comprising the larger cubic shape having a width greater than the width of the cubic shape of the treat.

15. The frozen meat treat device of claim 14, further comprising the width of the larger cubic shape being configured for being greater than fifty one millimeters.

16. The frozen meat treat device of claim 6, further comprising the larger cubic shape having a height greater than the height of the cubic shape of the treat.

17. The frozen meat treat device of claim 16, further comprising the height of the larger cubic shape being configured for being greater than fifty one millimeters.

18. A frozen meat treat device configured for being indulged by a canine or a pet animal, the frozen meat treat device comprising:
a treat being configured for being an indulgence for a canine or a pet animal, the treat being a cubic shape, the cubic shape having a length, the length of the cubic shape being configured for being fifty one millimeters, the cubic shape having a width, the width of the cubic shape being configured for being fifty one millimeters, the cubic shape having a height, the height of the cubic shape being configured for being fifty one millimeters, the treat being a meat, the meat being a beef, the meat being a chicken, the meat being a liver of a livestock, the meat being configured for being baked at a temperature, the temperature being configured for being one hundred thirty five Centigrade, the temperature being configured for partially baking the meat wherein retaining a juice of the meat; and
an ice cube enwrapping the treat, the ice cube being a larger cubic shape, the larger cubic shape being large-scaled relative to the cubic shape of the treat, the larger cubic shape having a length greater than the length of the cubic shape of the treat, the length of the larger cubic shape being configured for being greater than fifty one millimeters, the larger cubic shape having a width greater than the width of the cubic shape of the treat, the width of the larger cubic shape being configured for being greater than fifty one millimeters, the larger cubic shape having a height greater than the height of the cubic shape of the treat, the height of the larger cubic shape being configured for being greater than fifty one millimeters, the ice cube comprising frozen water and the juice of the meat, the ice cube being configured for quenching a thirst of the canine or the pet animal.

19. A method for creating a frozen meat treat for a canine or a pet animal, the method comprising a step of:
cutting a meat into a treat;
forming the treat into a cubic shape;
baking the treat at a temperature of one hundred thirty five Centigrade from ten to twenty minutes;
placing the treat within a cavity of an ice tray;
filling the cavity with water;
submerging the treat within water in the cavity;
positioning the ice tray in a space having an ambient temperature less than zero Centigrade;
producing an ice cube around the treat within the cavity of the ice tray;
removing the ice cube from the cavity of the ice tray; and
feeding the ice cube to a canine or a pet animal.
